(19) United States
(12) Patent Application Publication
(10) Pub. No.: US 2012/0081526 A1
(43) Pub. Date: Apr. 5, 2012

(54) IMAGE DISPLAY METHOD AND IMAGE DISPLAY SYSTEM FOR INCREASING HORIZONTAL BLANKING INTERVAL DATA TO GENERATE ADJUSTED HORIZONTAL BLANKING INTERVAL DATA

(76) Inventors: Wei-Heng Huang, New Taipei City (TW); Chao-Shih Huang, New Taipei City (TW); Shou-Chih Chen, New Taipei City (TW); Chueh-Pin Ko, New Taipei City (TW)

(21) Appl. No.: 13/221,907

(22) Filed: Aug. 31, 2011

Related U.S. Application Data
(60) Provisional application No. 61/389,695, filed on Oct. 4, 2010.

(30) Foreign Application Priority Data
Feb. 15, 2011 (TW) 100104886

(51) Int. Cl. H04N 13/04; H04N 7/087; H04N 7/084

(52) U.S. Cl. 348/54; 348/479; 348/478; 348/E13.075; 348/E07.027; 348/E07.03

(57) ABSTRACT

An image display method includes increasing a horizontal blanking interval (HBI) data included in a scan line data corresponding to at least a scan line and accordingly generating an adjusted HBI data; and transmitting a non-HBI data included in the scan line data and the adjusted HBI data to a display screen. An image display system includes a display screen, an adjusting circuit, and an output circuit. The adjusting circuit is arranged for increasing an HBI data included in a scan line data corresponding to at least a scan line and accordingly generating an adjusted HBI data. The output circuit is arranged for transmitting a non-HBI data included in the scan line data and the adjusted HBI data to the display screen.

### CROSS REFERENCE TO RELATED APPLICATIONS

This application claims the benefit of U.S. provisional application No. 61/389,695, filed on Oct. 4, 2010 and incorporated herein by reference.

### BACKGROUND OF THE INVENTION

1. Field of the Invention

The present invention relates to image display technique, and more particularly, to an image display method and image display system capable of finishing transmitting active data of an image frame in advance by adjusting/increasing a horizontal blanking interval (HBI) data included in at least one scan line.

2. Description of the Prior Art

Regarding a liquid crystal display (LCD) screen, the rotation of a liquid crystal (LC) cell requires a period of time to be stabilized. No matter whether an LCD screen which collaborates with a pair of 3D glasses (e.g., a pair of shutter glasses) is utilized for presenting a three-dimensional (3D) image to the user or an LCD screen is utilized for presenting a two-dimensional (2D) image to the user, how to finish refreshing an image in advance to avoid crosstalk becomes an important issue in this technical field.

### SUMMARY OF THE INVENTION

Therefore, one of the objectives of the present invention is to provide an image display method and an image display system capable of finishing transmitting active data of an image frame in advance by adjusting/increasing a horizontal blanking interval (HBI) data included in at least one scan line.

According to a first aspect of the present invention, an image display method is disclosed. The image display method includes: increasing an HBI data included in a scan line data corresponding to a scan line and accordingly generating an adjusted HBI data; and transmitting a non-HBI data included in the scan line data and the adjusted HBI data to a display screen.

According to a second aspect of the present invention, an image display system is disclosed. The image display system includes a display screen, an adjusting circuit and an output circuit. The adjusting circuit is utilized for increasing an HBI data included in a scan line data corresponding to a scan line and accordingly generating an adjusted HBI data. The output circuit is coupled to the adjusting circuit and the display screen, for transmitting a non-HBI data included in the scan line data and the adjusted HBI data to the display screen.

According to a third aspect of the present invention, an image display method is disclosed. The image display method includes: adjusting an HBI data included in a scan line data corresponding to at least a scan line in order to make a plurality of corresponding scan line data of a plurality of scan lines having HBI data of different lengths, wherein the plurality of scan lines correspond to driving of a same image driver and comprise the scan line; and transmitting the plurality of corresponding scan line data of the plurality of scan lines to a display screen.

According to a fourth aspect of the present invention, an image display system is disclosed. The image display system includes a display screen, an adjusting circuit and an output circuit. The adjusting circuit is utilized for adjusting an HBI data included in a scan line data corresponding to at least a scan line in order to make a plurality of corresponding scan line data of the plurality of scan lines having HBI data of different lengths; wherein the plurality of scan lines correspond to driving of a same image driver and include the scan line. The output circuit is coupled to the display screen and the adjusting circuit, for transmitting the plurality of corresponding scan line data of the plurality of scan lines to the display screen.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a function block diagram illustrating an image display system according to a first exemplary embodiment of the present invention.

FIG. 2 is a diagram illustrating an output image of a display screen shown in FIG. 1.

FIG. 3 is a simplified diagram illustrating the output image of the display screen shown in FIG. 2.

FIG. 4 is a diagram illustrating a first exemplary embodiment of the adjusted HBI data generated by an adjusting circuit shown in FIG. 1.

FIG. 5 is a diagram illustrating the operation of increasing HBI data for finishing transmission of the active data of a full image in advance.

FIG. 6 is a diagram illustrating a second exemplary embodiment of adjusted HBI data generated by the adjusting circuit shown in FIG. 1.

FIG. 7 is a diagram illustrating a third exemplary embodiment of adjusted HBI data generated by the adjusting circuit shown in FIG. 1.

FIG. 8 is a diagram illustrating a fourth exemplary embodiment of adjusted HBI data generated by the adjusting circuit shown in FIG. 1.

FIG. 9 is a diagram illustrating a fifth exemplary embodiment of adjusted HBI data generated by the adjusting circuit shown in FIG. 1.

FIG. 10 is a diagram illustrating a sixth exemplary embodiment of adjusted HBI data generated by the adjusting circuit shown in FIG. 1.

FIG. 11 is a diagram illustrating a seventh exemplary embodiment of adjusted HBI data generated by the adjusting circuit shown in FIG. 1.

FIG. 12 is a diagram illustrating an eighth exemplary embodiment of adjusted HBI data generated by the adjusting circuit shown in FIG. 1.

FIG. 13 is a function block diagram illustrating an image display system according to a second exemplary embodiment of the present invention.

FIG. 14 is a function block diagram illustrating an image display system according to a third exemplary embodiment of the present invention.

FIG. 15 is a function block diagram illustrating an image display system according to a fourth exemplary embodiment of the present invention.

### DETAILED DESCRIPTION

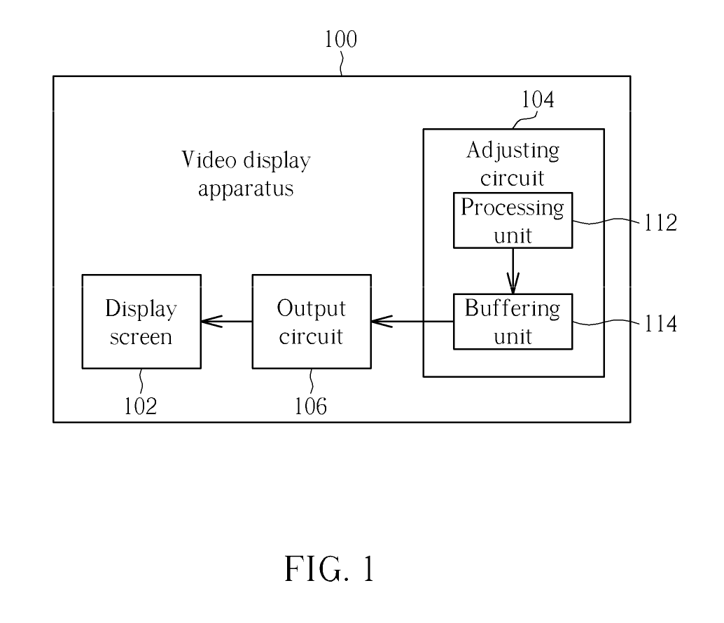

Please refer to FIG. 1, which is a function block diagram illustrating an image display system according to a first exemplary embodiment of the present invention. In this exemplary embodiment, the image display system is realized by a video display apparatus 100. As shown in the figure, the video display apparatus 100 includes, but is not limited to, a display screen 102, an adjusting circuit 104 and an output circuit 106. The adjusting circuit 104 increases a horizontal blanking interval (HBI) data included in a scan line data corresponding to at least a scan line, and accordingly generates an adjusted HBI data. The output circuit 106 transmits a non-HBI data included in the scan line and the adjusted HBI data to the display screen 102. In this exemplary embodiment, the adjusting circuit 104 includes, but is not limited to, a processing unit 112 and a buffering unit 114. For example, the processing unit 112 may be a scalar which may process scan line data corresponding to each scan line by an internal micro-processor thereof. Besides, the buffering unit 114 may be a frame buffer which is utilized for temporarily storing the data to be transmitted to the display screen 102. Therefore, as to the scan line data corresponding to the aforementioned scan line to be processed, the processing unit 112 temporarily stores non-HBI data which is not the HBI data into the buffering unit 114, directly. Moreover, as to the HBI data, the processing unit 112 increases this HBI data and accordingly generates an adjusted HBI data. Please note that the data amount of the adjusted HBI data is larger than the data amount of the original HBI data. Besides, the processing unit 112 temporarily stores the adjusted HBI data in the buffering unit 114. Next, the output circuit 106 reads the scan line data, including the original non-HBI data and the adjusted HBI data and corresponding to the aforementioned scan line to be processed, from the buffering unit 114, and transmits it to the display screen 102 for the following image display. Please note that the aforementioned non-HBI data may be an active data corresponding to an active display area or a vertical blanking interval (VBI) data corresponding to a vertical blanking interval (VBI), and further illustrations are described below.

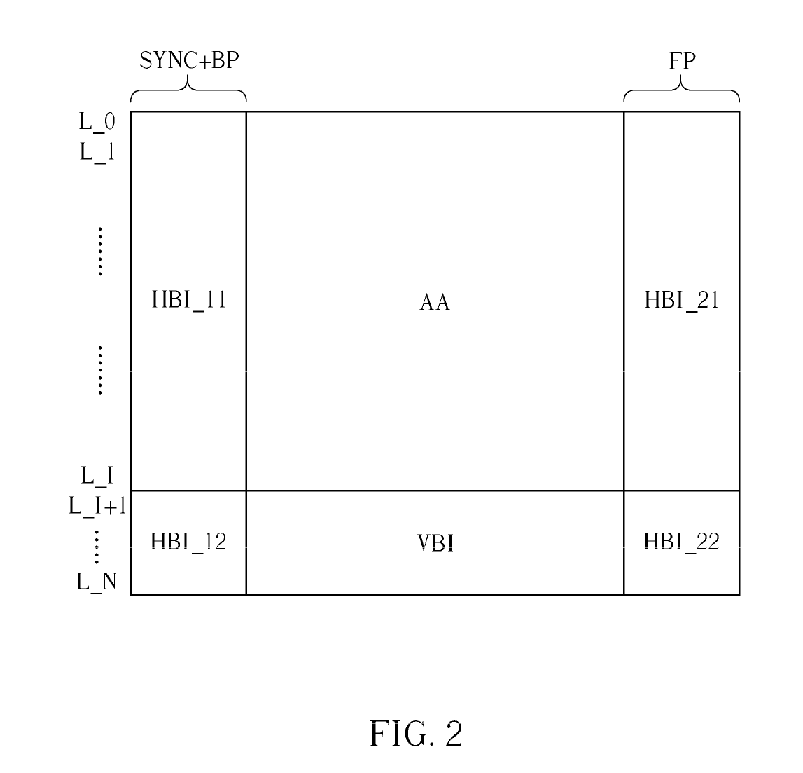

Please refer to FIG. 2, which is a diagram illustrating an output image of the display screen shown in FIG. 1. As shown in the figure, the output image of the display screen 102 may be divided into an active display area AA and a blanking area including HBI areas HBI_11, HBI_12, HBI_21, HBI_22 and a vertical blanking interval area VBI, wherein the HBI areas HBI_11 and HBI_21 correspond to the active display area AA horizontally, and the HBI areas HBI_12 and HBI_22 correspond to the vertical blanking interval area VBI horizontally. Moreover, the output image of the display screen 102 may be regarded as a display result of the scan line data of a plurality of scan lines L_0−L_N, wherein the scan lines L_1−L_I correspond to the active display area AA, and the scan lines L_I+1−L_N correspond to the vertical blanking interval area VBI. The scan line data of each of the scan lines L_0−L_I includes an HBI data and a non-HBI data (i.e., an active data), wherein the HBI data which belongs to the HBI area HBI_11 sequentially includes a synchronization signal SYNC and a back porch signal BP, and the HBI data which belongs to another HBI area HBI_21 includes a front porch signal FP. Moreover, the scan line data of each of the scan lines L_I+1−L_N also includes an HBI data and a non-HBI data (i.e., a VBI data), wherein the HBI data which belongs to the HBI area HBI_12 sequentially includes a synchronization signal SYNC and a back porch signal BP, and the HBI data which belongs to another HBI area HBI_22 includes a front porch signal FP.

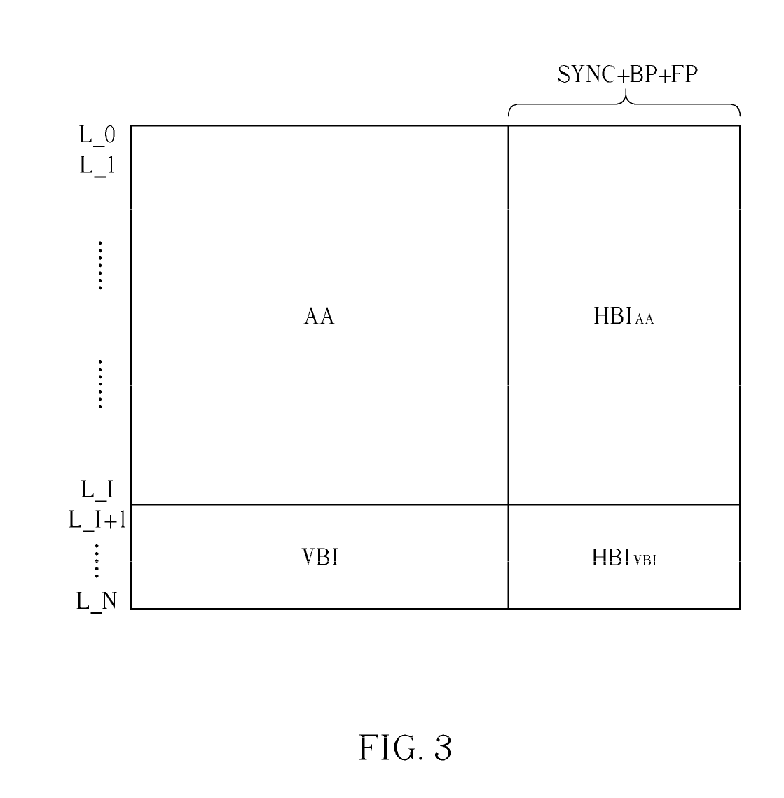

As aforementioned, the scan line data of each of the scan lines L_0−L_N includes an HBI data (i.e., a synchronization signal SYNC, a back porch signal BP and a front porch signal FP) and a non-HBI data (i.e., an active data or a VBI data). In order to facilitate illustration of the technical features of the present invention, the output image of the display screen 102 may also be represented by FIG. 3. The output image of the display screen 102 may be divided into an active display area AA and a blanking area including HBI areas HBI_{AA}, HBI_{VBI} and a vertical blanking interval area VBI, wherein the HBI area HBI_{AA} corresponds to the active display area AA horizontally, and may be regarded as a collection of synchronization signals SYNC, back porch signals BP and front porch signals FP of the scan lines L_0−L_I+1. Moreover, the HBI area HBI_{VBI} corresponds to the vertical blanking interval area VBI horizontally, and may be regarded as a collection of synchronization signals SYNC, back porch signals BP and front porch signals FP of the scan lines L_I−L_N. In other words, the operation of adjusting the HBI data as mentioned in this exemplary embodiment of the present invention may be an operation of adjusting the synchronization signal SYNC, the back porch signal BP, and/or the front porch signal FP.

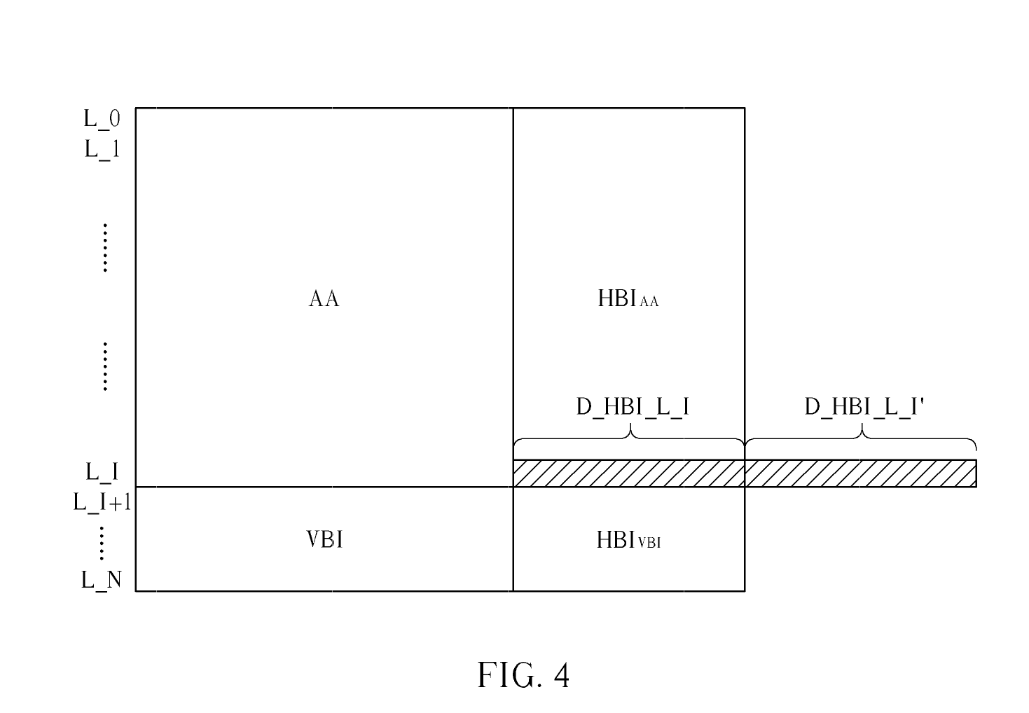

Please refer to FIG. 4, which is a diagram illustrating a first exemplary embodiment of the adjusted HBI data generated by the adjusting circuit shown in FIG. 1. In this exemplary embodiment, the scan line adjusted by the adjusting circuit 104 corresponds to the last scan line L_I within the active display area AA displayed on the display screen 102. In a case where the resolution of the active display area AA is 1920×1080, the scan line adjusted by the adjusting circuit 104 is the 1080^{th} scan line corresponding to the active display area AA. Therefore, in addition to the original HBI data D_HBI_L_I, the adjusted HBI data includes the newly added HBI data D_HBI_L_I′. In other words, the adjusted HBI data is D_HBI_L_I+D_HBI_L_I′. So, the newly added HBI data D_HBI_L_I may be regarded as the extended HBI data of the original HBI data D_HBI_L_I. Therefore, the transmission of other data may be accelerated due to the newly added HBI data D_HBI_L_I′. In this way, since the output circuit 106 may finish transmitting the active data corresponding to the active display area AA to the display screen 102 in advance, the display screen 102 (e.g., an LCD screen) has more time to finish stabilization of the full image frame, thereby improving the image quality greatly.

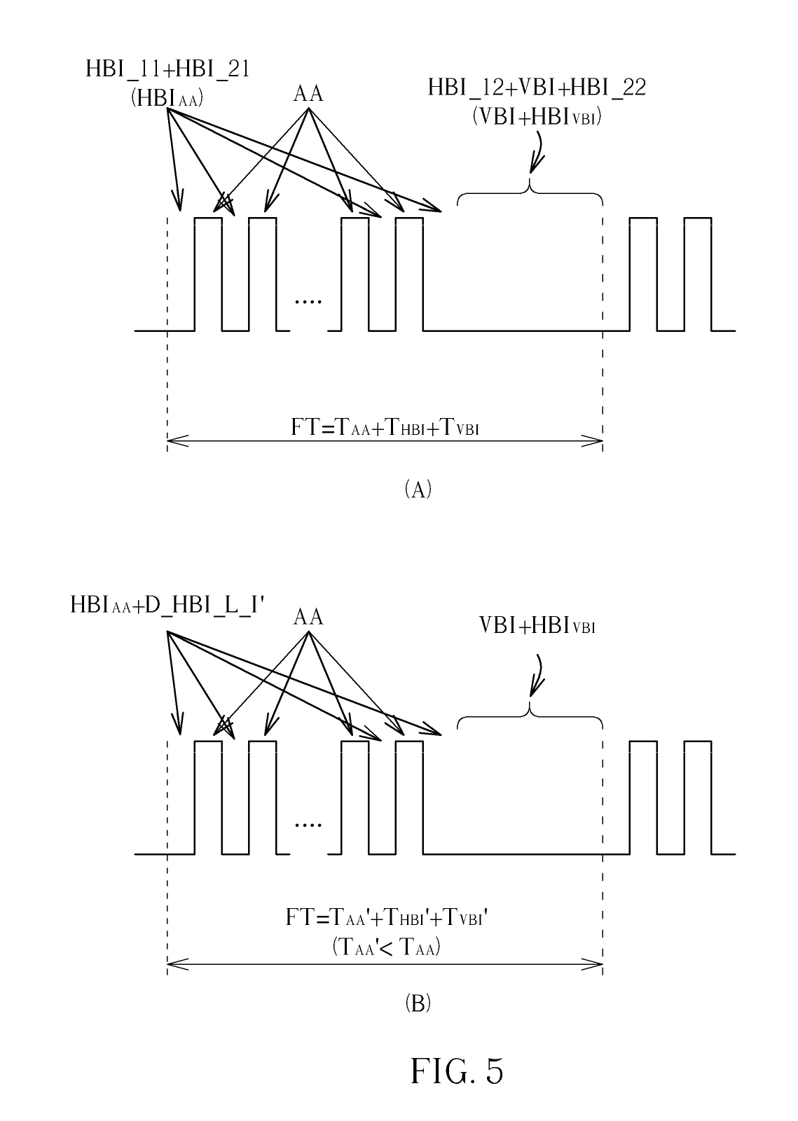

Please refer to FIG. 5, which is a diagram illustrating the operation of increasing the HBI data for allowing transmission of the active data of a full image to be finished in advance. In the sub-diagram (A) of FIG. 5, as the driving mechanism of the present invention is not utilized for increasing HBI data of any scan line, the driving period of a full image may be simply expressed as below:

FT=T_{AA}+T_{HBI}+T_{VBI} (1)

In the aforementioned equation (1), FT represents the period required for driving the full image, T_{AA} represents the period required by the output circuit 106 for transmitting the active data of the active display area AA within the full image to the display screen 102, T_{HBI} represents the period required by the output circuit 106 for transmitting the HBI data corresponding to the HBI areas HBI_{AA} and HBI_{VBI} to the display screen 102, and T_{VBI} represents the period required by the output circuit 106 for transmitting the VBI data corresponding to the vertical blanking interval area VBI to the display screen 102.

In the sub-diagram (B) of FIG. 5, the driving mechanism of the present invention is utilized for increasing the HBI data included in the last scan line L_I within the active display area AA displayed on the display screen 102. The driving period of a full image may be simply expressed as below:

FT=T_{AA}′+T_{HBI}′+T_{VBI}′ (2)

In the aforementioned equation (2), T_{AA}′ represents the period required by the output circuit 106 for transmitting the active data of the active display area AA within the full image frame to the display screen 102, T_{HBI}′ represents the period required by the output circuit 106 for transmitting the original HBI data and the newly added HBI data D_HBI_L_I′ corresponding to the HBI area HBI_{AA} and HBI_{VBI} to the display screen 102, and T_{VBI}′ represents the period required by the output circuit 106 for transmitting the VBI data corresponding to the vertical blanking interval area VBI to the display screen 102.

As clearly shown in FIG. 5, under a condition where the driving period FT of the full image is the same, the output circuit 106 would utilize a larger bandwidth for data transmission when the output circuit 106 needs to transmit the newly added HBI data D_HBI_L_I′. Therefore, T_{AA}′ is smaller than T_{AA} (i.e., T_{AA}′<T_{AA}). In other words, compared with the conventional driving mechanism, the driving mechanism of the present invention finishes transmitting the active data in advance, so the display screen 102 (i.e., an LCD screen) has more time to stabilize the image output.

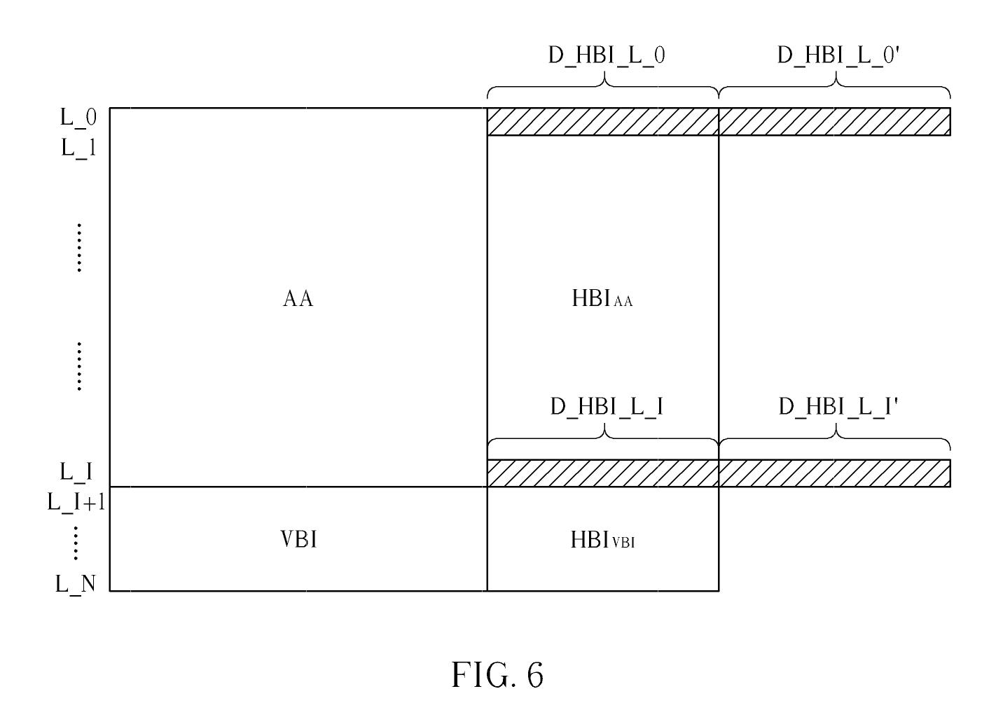

In the exemplary embodiment shown in FIG. 4, the adjusting circuit 104 only adjusts/increases the HBI data of a single scan line (i.e., the scan line L_I). However, it is for illustrative purposes only, and is not meant to be a limitation of the present invention. Please refer to FIG. 6, which is a diagram illustrating a second exemplary embodiment of the adjusted HBI data generated by the adjusting circuit shown in FIG. 1. The adjusting circuit 104 may adjust the HBI data of a plurality of scan lines. For example, the scan lines adjusted by the adjusting circuit 104 correspond to the first scan line L_0 and the last scan line L_I within the active display area AA displayed on the display screen 102. Therefore, in addition to the original HBI data D_BHI_L_0, D_HBI_L_I, the adjusted HBI data further includes newly added HBI data D_HBI_L_0′, D_HBI_L_I′. Similarly, due to the newly added HBI data D_HBI_L_0′, D_HBI_L_I′, the output circuit 106 would utilize a larger bandwidth for data transmission, thereby achieving the objective of finishing the transmission of the active data in advance.

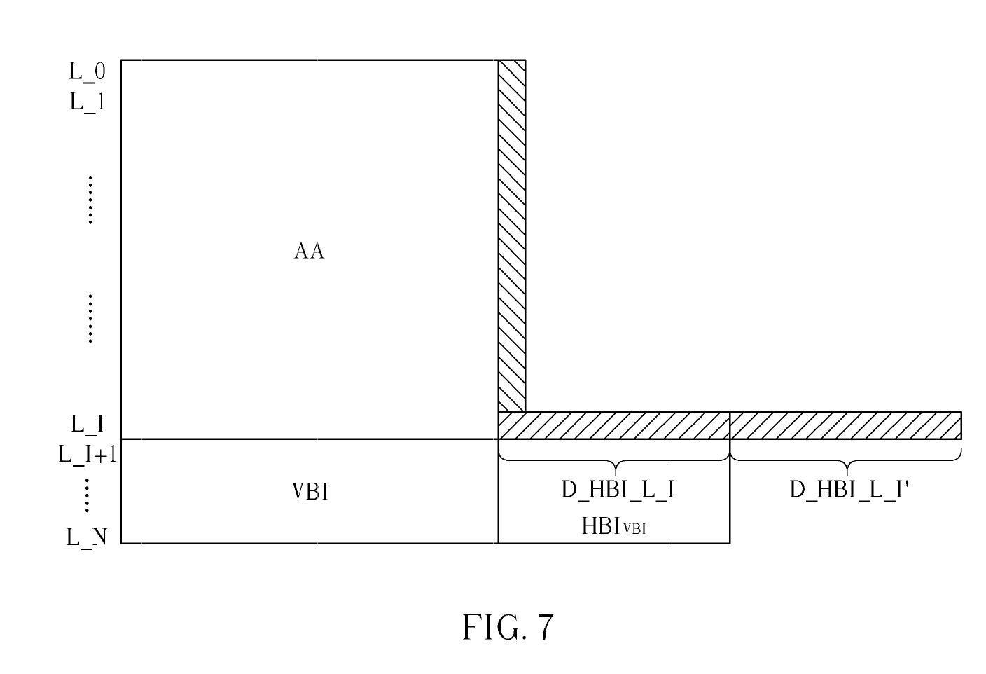

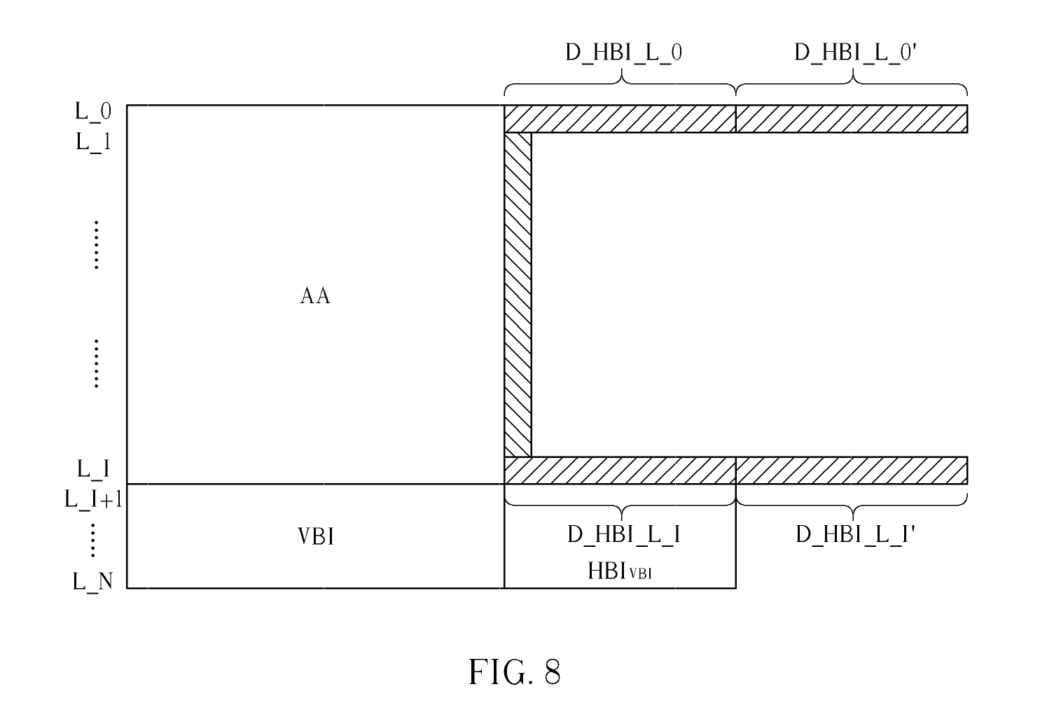

In the exemplary embodiment shown in FIG. 4, the adjusting circuit 104 only increases the HBI data of the last scan line L_I within the active display area AA displayed on the display screen 102, and does not adjust the HBI data of other scan lines within the active display area AA displayed on the display screen 102. Similarly, in the exemplary embodiment shown in FIG. 6, the adjusting circuit 104 only increases the HBI data of the first scan line L_0 and the last scan line L_I within the active display area AA displayed on the display screen 102, and does not adjust the HBI data of other scan lines within the active display area AA displayed on the display screen 102. However, it is for illustrative purposes only, and is not meant to be a limitation of the present invention. Please refer to FIG. 7 and FIG. 8. FIG. 7 is a diagram illustrating a third exemplary embodiment of adjusted HBI data generated by the adjusting circuit shown in FIG. 1. FIG. 8 is a diagram illustrating a fourth exemplary embodiment of adjusted HBI data generated by the adjusting circuit shown in FIG. 1. In the exemplary embodiments shown in FIG. 7 and FIG. 8, the adjusting circuit 104 further decreases the HBI data of other scan lines within the active display area AA displayed on the display screen 102. Therefore, the newly added HBI data D_HBI_L_0′, D_HBI_L_I′ is allowed to have a larger data amount. These alternative designs also fall within the scope of the present invention.

In the aforementioned exemplary embodiments shown in FIG. 4, FIG. 6, FIG. 7 and FIG. 8, all of the scan lines adjusted by the adjusting circuit 104 correspond to the active display area AA displayed on the display screen 102. That is, the non-HBI data in the aforementioned exemplary embodiments is the active data of the active display area AA. However, in other exemplary embodiments, the non-HBI data may be a VBI data corresponding to the vertical blanking interval area VBI.

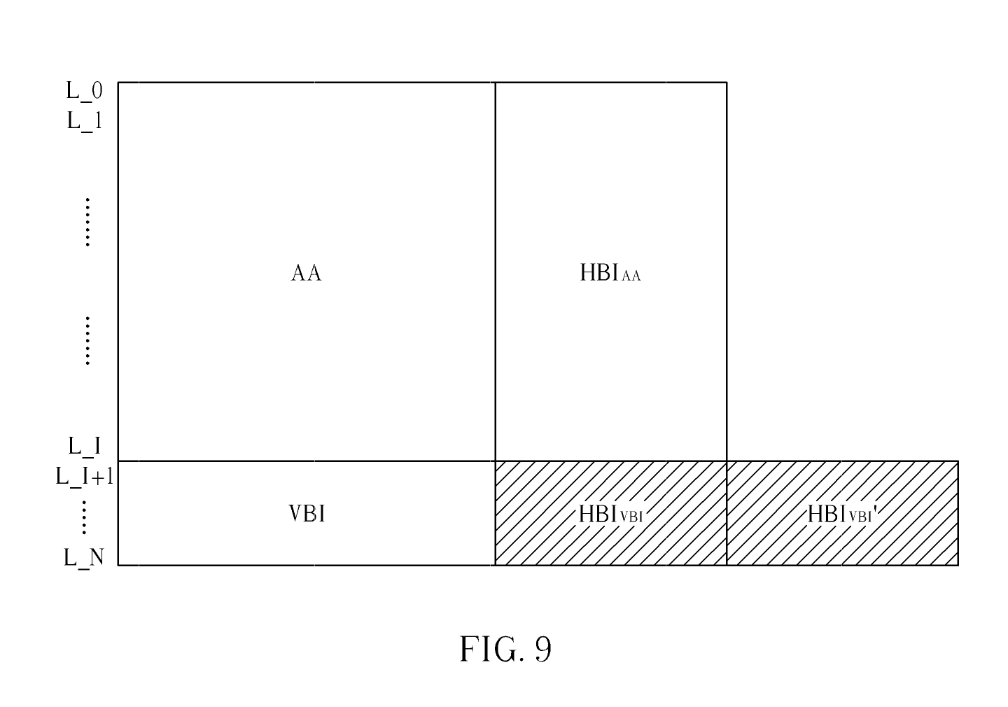

Please refer to FIG. 9, which is a diagram illustrating a fifth exemplary embodiment of adjusted HBI data generated by the adjusting circuit shown in FIG. 1. In this exemplary embodiment, the scan lines adjusted by the adjusting line 104 correspond to the scan lines L_I+1−L_N within the vertical blanking interval area VBI corresponding to the display screen 102. Therefore, in addition to the original VBI data HBI_{VBI}, the adjusted HBI data includes newly added HBI data HBI_{VBI}′. In brief, the newly added HBI data HBI_{VBI}′ may be regarded as the extended HBI data of the original HBI data HBI_{VBI}. Thus, due to the newly added HBI data HBI_{VBI}′, the transmission of other data may be accelerated. Since the output circuit 106 may finish transmitting the active data corresponding to the active display area AA to the display screen 102 in advance, the display screen 102 (e.g., an LCD screen) has more time to finish stabilizing the full image display. As those skilled in the art should readily know the operational principle of increasing the VBI data corresponding to the vertical blanking interval area VBI for finishing the transmission of the active data of a full image in advance according to the related description pertinent to FIG. 5, further description is omitted here for brevity.

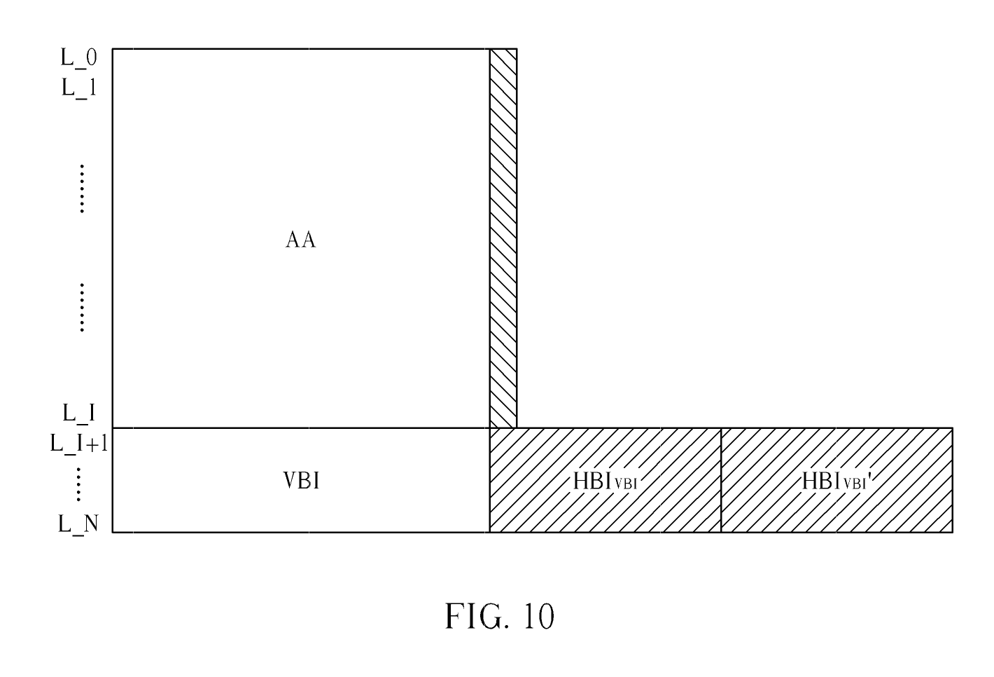

In the exemplary embodiment shown in FIG. 9, the adjusting circuit 104 only increases the VBI data of the scan lines corresponding to the vertical blanking interval area VBI, and does not adjust the HBI data of the scan lines of the active display area AA displayed on the display screen 102. However, it is for illustrative purposes only, and is not meant to be a limitation of the present invention. Please refer to FIG. 10, which is a diagram illustrating a sixth exemplary embodiment of adjusted HBI data generated by the adjusting circuit 104 shown in FIG. 1. In the exemplary embodiment shown in FIG. 10, the adjusting circuit 104 further decreases the HBI data of the scan lines L_0−L_I within the active display area AA displayed on the display screen 102. In this way, the newly added HBI data HBI_{VBI}′ is allowed to have a larger data amount.

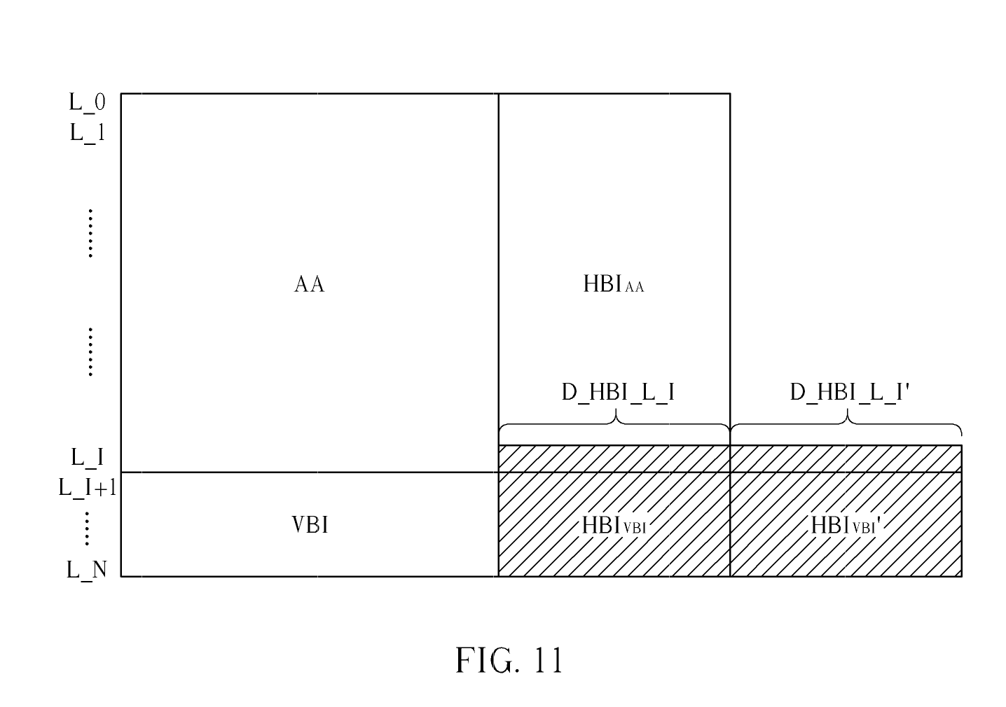

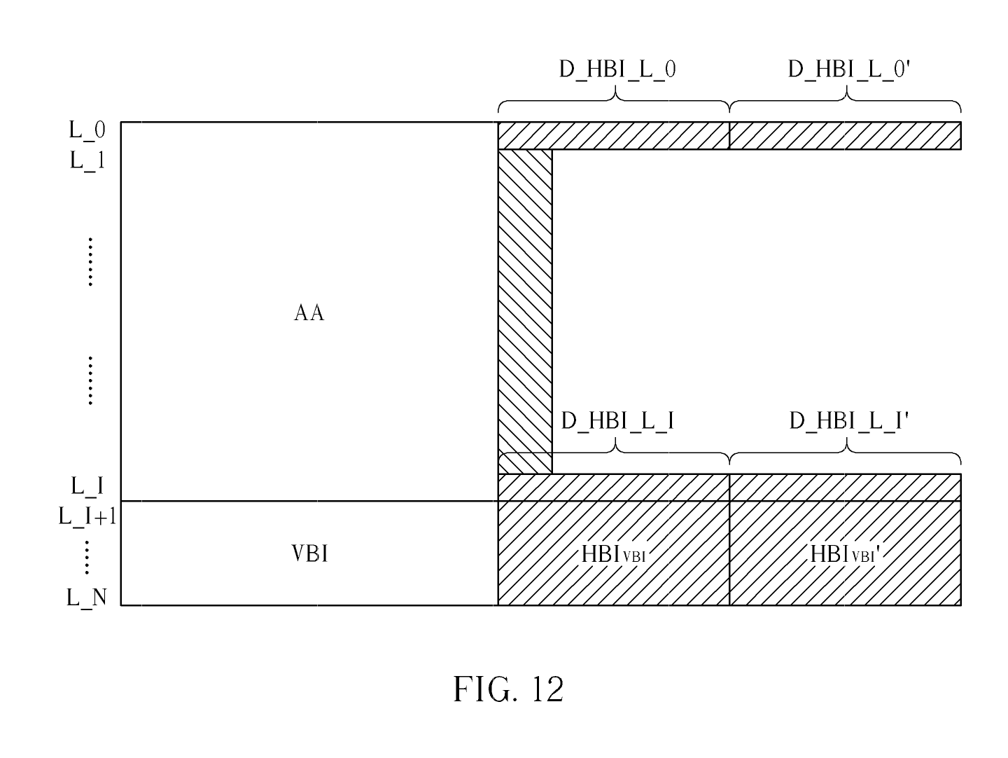

Moreover, any of the exemplary embodiments shown in FIG. 9 and FIG. 10 may be properly modified based on any of the exemplary embodiments shown in FIG. 4, FIG. 6, FIG. 7 and FIG. 8, as shown in FIG. 11 and FIG. 12. FIG. 11 is a diagram illustrating a seventh exemplary embodiment of adjusted HBI data generated by the adjusting circuit 104 shown in FIG. 1. FIG. 12 is a diagram illustrating an eighth exemplary embodiment of adjusted HBI data generated by the adjusting circuit 104 shown in FIG. 1. The exemplary embodiment shown in FIG. 11 may be regarded as a result of combining exemplary embodiments shown in FIG. 9 and FIG. 4, and the exemplary embodiment shown in FIG. 12 may be regarded as a result of combining exemplary embodiments shown in FIG. 10 and FIG. 8. Since those skilled in the art should readily know the technical features of the exemplary embodiments shown in FIG. 11 and FIG. 12 after reading above paragraphs, further description is omitted here for brevity.

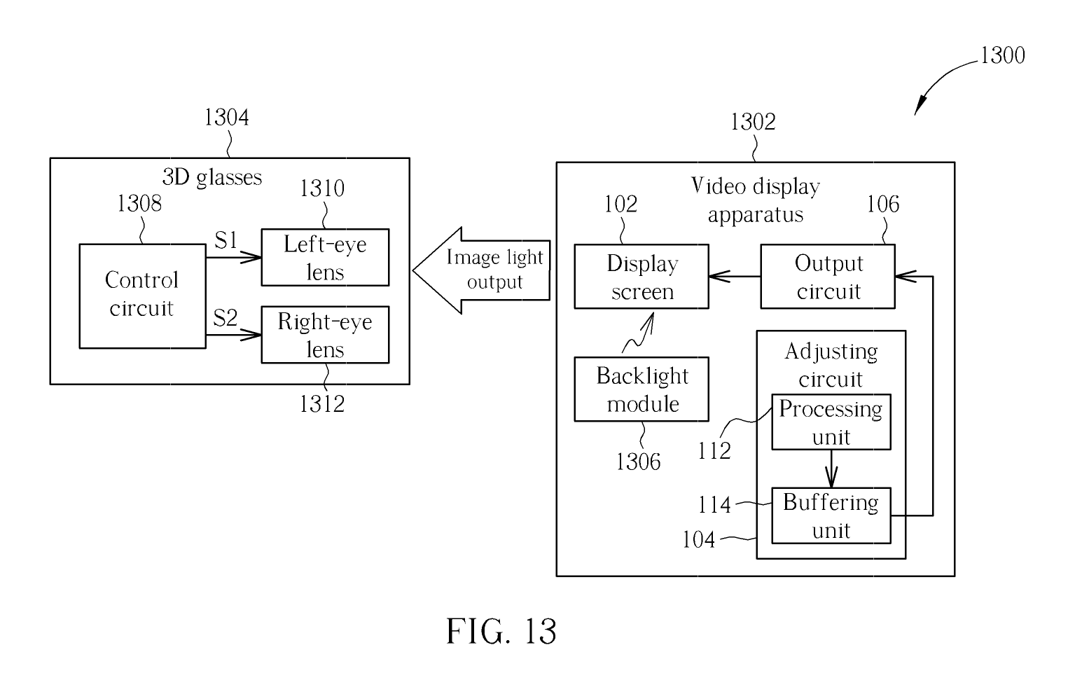

Please note that, in addition to the 2D image display, the driving mechanism proposed in the present invention may be applied to the 3D image display. Please refer to FIG. 13, which is a function block diagram illustrating an image display system according to a second exemplary embodiment of the present invention. In this exemplary embodiment, the image display system 1300 includes, but is not limited to, a video display apparatus 1302 and a pair of 3D glasses 1304. The video display apparatus 1302 includes the aforementioned display screen 102, output circuit 106 and adjusting circuit 104, and further includes a backlight module 1306 for providing a backlight source needed by the display screen (e.g., an LCD screen) 102. The pair of 3D glasses 1304 includes, but is not limited to, a control circuit 1308, a left-eye lens 1310 and a right-eye lens 1312. The video display apparatus 1302 collaborates with the 3D glasses 1304 for presenting 3D images to the user. The left-eye lens 1310 is utilized for allowing the user to view the left-eye images, and the right-eye lens 1312 is utilized for allowing the user to view right-eye images. Besides, the control circuit 1308 is electrically connected to the left-eye lens 1310 and the right-eye lens 1312, and respectively outputs control signals S1, S2 to the left-eye lens 1310 and the right-eye lens 1312 for controlling the left-eye lens 1310 to switch between an on-state and an off-state and controlling the right-eye lens 1312 to switch between an on-state and an off-state. For example, the 3D glasses 1304 are shutter glasses. The left-eye lens 1310 and the right-eye lens 1312 are both shutter lens, and respectively have liquid crystal (LC) layers. The control signals S1, S2 may be control voltages for controlling the rotation of the LC cells within the LC layers in order to achieve the objective of controlling the light transmission rate. However, it is for illustrative purposes only, and is not meant to be a limitation of the present invention. For example, any structure that is capable of controlling the light transmission rate may be utilized for realizing each of the left-eye lens 1310 and the right-eye lens 1312. The same objective of controlling the left-eye lens 1310 and the right-eye lens 1312 to switch between an on-state and an off-state is achieved. Moreover, the pair of 3D glasses 1304 is not limited to a pair of shutter glasses. Any pair of 3D glasses that collaborates with the video display apparatus 1302 for allowing the user to view 3D images and is suitable to be used in the 3D image display mechanism disclosed by the present invention obeys the spirit of the present invention.

In the present invention, the “off-state” described above means that the left-eye lens/the right-eye lens is totally opaque (i.e., the light transmission rate is 0%). Therefore, as long as the first shutter lens/the second shutter lens is not totally opaque (i.e., the light transmission rate is not 0%), it may be regarded as staying in the “on-state”. For example, when the shutter lens is fully open (e.g., the light transmission rate is 100%), half open (e.g., the light transmission rate is 50%), or slightly open (e.g., the light transmission rate is 0.1%), the shutter lens may be regarded as staying in an on-state. In brief, when the light transmission rate of the left-eye lens/the right-eye lens is larger than 0% (but smaller than or equal to 100%), the left-eye lens/the right-eye lens is staying in an on-state.

A user may wear the pair of 3D glasses 1304 to view 3D images presented by the video output apparatus 1302. For example, in the exemplary embodiment shown in FIG. 1, the video output apparatus 1302 may be an LCD apparatus, and the pair of 3D glasses 1304 controls whether the image light output generated by the display screen 102 may reach user's left eye or right eye. Please note that the video output apparatus 1302 is not limited to be realized by an LCD apparatus. That is, the video output apparatus 1302 may by any video output apparatus that collaborates with the pair of 3D glasses 1304 for presenting 3D images to the user. In other words, if the pair of 3D glasses 1304 is a pair of shutter glasses, the video display apparatus 1302 may be any display apparatus or projector that collaborates with the pair of shutter glasses.

Regarding the exemplary embodiment of using a pair of shutter glasses as the pair of 3D glasses, the control circuit 1308 may be utilized for properly controlling the left-eye lens 1310 and the right-eye lens 1312 to switch between an on-state and an off-state. For example, the video display apparatus 1302 may communicate with the pair of 3D glasses 1304 through a signal transmitter (not shown). For example, the pair of 3D glasses (e.g., a pair of shutter glasses) 1304 may receive information transmitted by the video display apparatus 1302 via wired or wireless transmission (e.g., infrared transmission, ZigBee transmission, ultrawideband (UWB) transmission, WiFi transmission, radio frequency (RF) transmission, DLP light signal transmission or Bluetooth transmission). The control circuit 118 may generate the required control signals S1, S2 based on the received information. Since those skilled in the art should readily know the communication mechanism between the pair of 3D glasses and the video display apparatus, further description is omitted here for brevity.

As to the image display system 1300 shown in FIG. 13, the at least one scan line adjusted by the adjusting circuit 104 corresponds to the last scan line L_I within the active display area AA displayed on the display screen 102. Therefore, in addition to the original HBI data D_HBI_L_I, the adjusted HBI data further includes newly added HBI data D_HBI_L_I′. During the period in which the output circuit 106 transmits the adjusted HBI data, including D_HBI_L_I and D_HBI_L_I′, to the display screen 102, the backlight module 1306 corresponding to the display screen 102 is activated for providing the backlight source that the display screen 102 requires and/or the control circuit 1308 activates one of the left-eye lens 1310 and the right-eye lens 1312. In other words, by increasing the HBI data of the last scan line L_I within the active display area AA displayed on the display screen 102, the transmission of the active data is accelerated for allowing the display screen 102 (e.g., an LCD screen) to have more time to stabilize the full image display; besides, the period in which the newly added HBI data is transmitted may be utilized for allowing the user to view 3D images (i.e., activating a lens of the 3D glasses 1304 and/or activating the backlight module 1306).

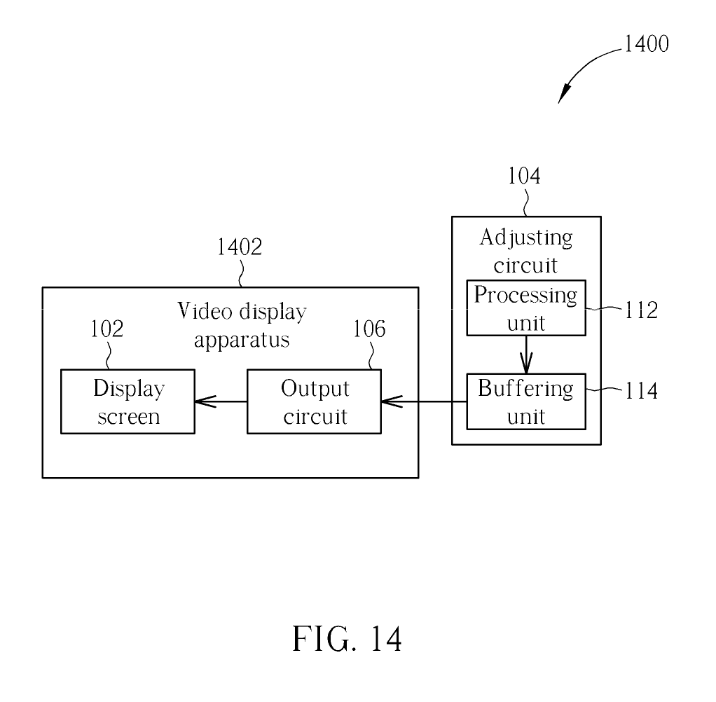

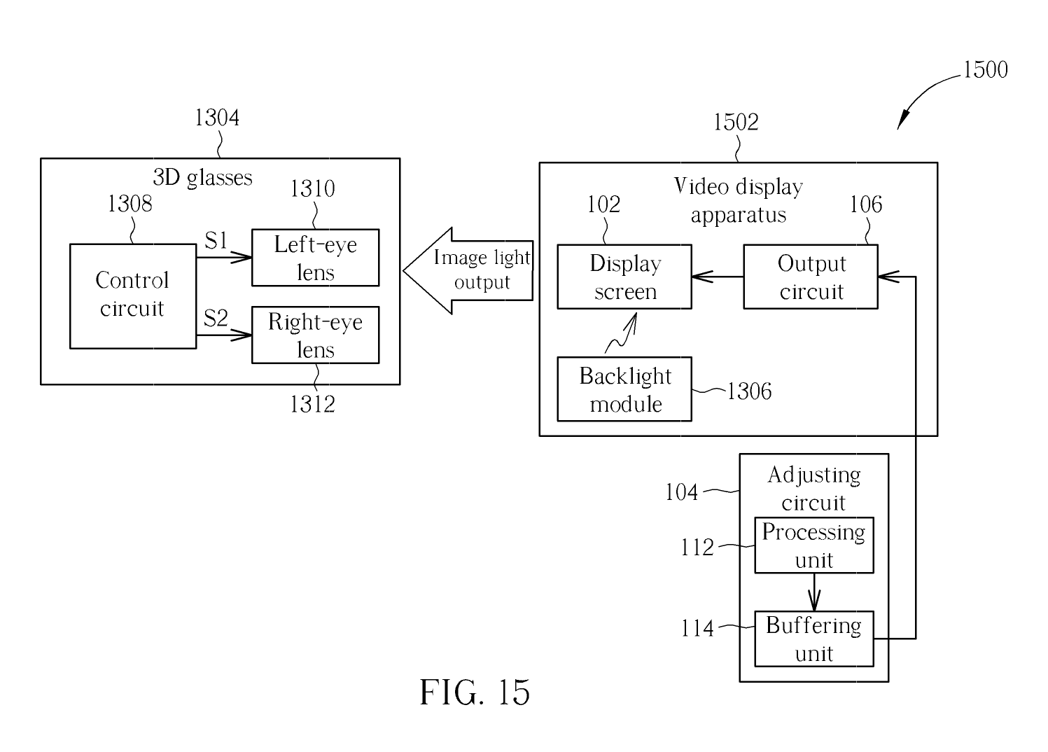

In the exemplary embodiments shown in FIG. 1 and FIG. 13, the adjusting circuit 104 is disposed within the video display apparatus (e.g., an LCD apparatus) 100, 1302. However, it is not meant to be a limitation of the present invention. Please refer to FIG. 14, which is a function block diagram illustrating an image display system according to a third exemplary embodiment of the present invention. The image display system 1400 includes, but is not limited to, a video display apparatus 1402 and the aforementioned adjusting circuit 104. The video display apparatus 1402 includes the aforementioned display screen 102 and output circuit 106. In this exemplary embodiment, the adjusting circuit 104 is disposed outside of the video display apparatus 1402. For example, the adjusting circuit 104 is disposed in a computer host. Therefore, after finishing the process of increasing the HBI data, the adjusting circuit 104 inputs the adjusted HBI data to the video display apparatus 1402 for transmitting the HBI data to the display screen 102 through the output circuit 106. Please refer to FIG. 15, which is a function block diagram illustrating an image display system according to a fourth exemplary embodiment of the present invention. The image display system 1500 includes, but is not limited to, a video display apparatus 1502 and the aforementioned adjusting circuit 104 and the pair of 3D glasses 1304. The video display apparatus 1502 includes the aforementioned display screen 102, the output circuit 106 and the backlight module 1306. In this exemplary embodiment, the adjusting circuit 104 is disposed outside of the video display apparatus 1502. For example, the adjusting circuit 104 is disposed in a computer host. Therefore, after finishing the process of increasing the HBI data, the adjusting circuit 104 inputs the adjusted HBI data to the video display apparatus 1502 for transmitting the HBI data to the display screen 102 through the output circuit 106. Since those skilled in the art should readily know the function and operation of each component shown in FIG. 14 and FIG. 15 after reading above paragraphs directed to other exemplary image display systems, further description is omitted here for brevity.

Briefly summarized, the image display method of the present invention may be simply concluded as below: increasing a horizontal blanking interval (HBI) data included in a scan line data corresponding to at least a scan line and accordingly generating an adjusted HBI data; and transmitting a non-HBI data (e.g., an active image data or a vertical blanking interval data) included in the scan line data and the adjusted HBI data to a display screen (e.g., an LCD screen). In other words, by adjusting an HBI data included in a scan line data corresponding to at least a scan line, a plurality of scan lines corresponding to driving of the same image would have HBI data of different lengths/different data amounts, respectively. For example, the scan line data corresponding to one part of the scan lines will have increased HBI data, and scan line data corresponding to another part of the scan lines will have the original HBI data or decreased HBI data). Since the increased HBI data makes the transmission of the active data corresponding to the active display area finished in advance, the display screen (e.g., an LCD screen) is allowed to have more time for stabilizing the image display, thereby improving the display quality of 2D/3D images greatly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image display method, comprising:
increasing a horizontal blanking interval (HBI) data included in a scan line data corresponding to at least a scan line, and accordingly generating an adjusted HBI data; and
transmitting a non-HBI data included in the scan line data and the adjusted HBI data to a display screen.

2. The image display method of claim 1, wherein the non-HBI data comprises an active data.

3. The image display method of claim 2, wherein the scan line corresponds to a last one of scan lines in an active display area presented by the display screen.

4. The image display method of claim 3, further comprising:
activating a lens of a pair of three-dimensional (3D) glasses during a period in which the adjusted HBI data is being transmitted to the display screen.

5. The image display method of claim 3, further comprising:
activating a backlight module corresponding to the display screen during a period in which the adjusted HBI data is being transmitted to the display screen.

6. The image display method of claim 1, wherein the non-HBI data comprises a vertical blanking interval (VBI) data.

7. The image display method of claim 1, further comprising:
receiving the scan line data corresponding to the scan line by a video display apparatus having the display screen included therein;
wherein the adjusted HBI data is generated by increasing the received HBI data.

8. An image display system, comprising:
a display screen;
an adjusting circuit, arranged for increasing a horizontal blanking interval (HBI) data included in a scan line data corresponding to at least a scan line and accordingly generating an adjusted HBI data; and
an output circuit, coupled to the adjusting circuit and the display screen, the output circuit arranged for transmitting a non-HBI data included in the scan line data and the adjusted HBI data to the display screen.

9. The image display system of claim 8, wherein the non-HBI data comprises an active data.

10. The image display system of claim 9, wherein the scan line corresponds to a last one of scan lines in an active display area presented by the display screen.

11. The image display system of claim 10, further comprising:
a pair of three-dimensional (3D) glasses;
wherein a lens of the pair of 3D glasses is activated during a period in which the adjusted HBI data is being transmitted to the display screen.

12. The image display system of claim 10, further comprising:
a backlight module;
wherein the backlight module corresponding to the display screen is activated during a period in which the adjusted HBI data is being transmitted to the display screen.

13. The image display system of claim 8, wherein the non-HBI data comprises a vertical blanking interval (VBI) data.

14. An image display method, comprising:
adjusting a horizontal blanking interval (HBI) data included in a scan line data corresponding to at least a scan line in order to make a plurality of corresponding scan line data of a plurality of scan lines have HBI data of different lengths, wherein the plurality of scan lines correspond to driving of a same image and include the scan line; and
transmitting the plurality of corresponding scan line data of the plurality of scan lines to a display screen.

15. The image display method of claim 14, wherein the scan line data corresponding to the scan line further comprises an active data.

16. The image display method of claim 15, wherein the scan line corresponds to a last one of scan lines in an active display area presented by the display screen.

17. The image display method of claim 16, further comprising:
activating a lens of a pair of three-dimensional (3D) glasses during a period in which an adjusted HBI data included in the scan line data corresponding to the scan line is being transmitted to the display screen.

18. The image display method of claim 16, further comprising:
activating a backlight module corresponding to the display screen during a period in which an adjusted HBI data included in the scan line data corresponding to the scan line is being transmitted to the display screen.

19. The image display method of claim 16, wherein the scan line data corresponding to the scan line further comprises a vertical blanking interval (VBI) data.

20. The image display method of claim 14, further comprising:
receiving the plurality of corresponding scan line data of the plurality of scan lines by a video display apparatus having the display screen included therein;
wherein an adjustment of the HBI data is based on the plurality of corresponding scan line data of the scan line.

21. An image display system, comprising:
a display screen;
an adjusting circuit, arranged for adjusting a horizontal blanking interval (HBI) data included in a scan line data corresponding to at least a scan line for making a plurality of corresponding scan line data of a plurality of scan lines have HBI data of different lengths; and
an output circuit, coupled to the display screen and the adjusting circuit, the output circuit arranged for transmitting the scan line data respectively corresponding to the plurality of scan lines to the display screen.

22. The image display system of claim 21, wherein the scan line data corresponding to the scan line further comprises an active data.

23. The image display system of claim 22, wherein the scan line corresponds to a last one of scan lines in an active display area presented by the display screen.

24. The image display system of claim 23, further comprising:
a pair of three-dimensional (3D) glasses;
wherein a lens of the pair of 3D glasses is activated during a period in which an adjusted HBI data included in the scan line data corresponding to the scan line is being transmitted to the display screen.

25. The image display system of claim 23, further comprising:
a backlight module;
wherein the backlight module corresponding to the display screen is activated during a period in which an adjusted HBI data included in the scan line data corresponding to the scan line is being transmitted to the display screen.

26. The image display system of claim 23, wherein the corresponding scan line data of the scan line further comprises a vertical blanking interval (VBI) data.
